(19) United States
(12) Patent Application Publication
(10) Pub. No.: US 2013/0103436 A1
(43) Pub. Date: Apr. 25, 2013

(54) MANAGING RELATIONSHIPS AND/OR INTERACTIONS BETWEEN VOTERS AND CANDIDATES

(71) Applicant: VoterBuzz, LLC, Bradenton, FL (US)

(72) Inventor: Andrea TORKELSON, Palmetto, FL (US)

(73) Assignee: VoterBuzz, LLC, Bradenton, FL (US)

(21) Appl. No.: 13/656,058

(22) Filed: Oct. 19, 2012

Related U.S. Application Data
(60) Provisional application No. 61/550,054, filed on Oct. 21, 2011.

(51) Int. Cl. G06Q 10/02

(52) U.S. Cl. 705/5

(57) ABSTRACT

The present disclosure includes systems and methods for providing an application or website that manages relationships and interactions between any of voters, members, candidates, committees, and/or organizations, Voters or members may perform functions such as view volunteer opportunities, apply for volunteer opportunities, contribute to campaigns, purchased tickets to events, respond to polls, upload content, send information to social media outlets, and join and follow candidates, committees, and/or organizations. Campaigns, committees, and/or organizations may perform functions such as sell tickets to events, manage campaign contributions, setup polls, send content to subscribers, and set contribution limits, such as those required by election laws or regulations.

This non-provisional application claims priority to U.S. Provisional Application No. 61/550,054, filed Oct. 21, 2011, the contents of which are expressly incorporated herein by reference.

### TECHNICAL FIELD

Embodiments of the present disclosure relate to systems and methods that aid in managing relationships or interactions between parties. In particular, exemplary embodiments of the present disclosure relate to aiding in the management of relationships and interactions between any of voters, members, candidates, committees, and/or organizations.

### BACKGROUND

Social networks, such as Facebook and Twitter, have grown in size and popularity in the past decade. As more users join these networks every day, the ability to spread information and ideas has become increasingly efficient. Social networks are now used by individuals to create and host events, share ideas, and develop new connections.

Recently, organizations, committees, and political parties have begun to use social networks to advertise products and campaign platforms. In the political arena, many politicians now have their own social network accounts, for gaining supporters and distributing campaign messages. However, current social networks have limited features for managing campaigns and for getting supporters involved. For example, members of current social networks are not able to search for candidates or campaigns drawn to a particular issue, or party. Furthermore, multiple websites managed by the political party are needed for various campaign functions such as selling event tickets, collecting/monitoring campaign contributions, and coordinating volunteer activities. Embodiments of the present disclosure address these and other shortcomings, and provide a comprehensive, social network-integrated tool for managing interactions between relationships between individuals such as between voters and candidates.

### BRIEF SUMMARY

The present disclosure includes systems and methods for providing an application or website that manages relationships and interactions between any of voters, members, candidates, committees, and/or organizations.

### BRIEF DESCRIPTION OF THE DRAWINGS

The accompanying drawings, which are incorporated in and constitute a part of this specification, illustrate various embodiments of the techniques, as described herein, and together with the description, serve to explain the principles of the techniques. In the drawings:

FIG. 1 is an illustration of a system that may be used with certain embodiments of the present disclosure;

FIGS. 2A and 2B illustrate examples of user account registration screens that may be used with certain embodiments of the present disclosure;

FIGS. 3A and 3B illustrate examples of user campaign view and filter screens that may be used with certain embodiments of the present disclosure;

FIGS. 4A and 4B illustrate examples of campaign profile and campaign individual view screens that may be used with certain embodiments of the present disclosure;

FIG. 5A illustrates an example of a user volunteer screen that may be used with certain embodiments of the present disclosure;

FIGS. 5B and 6A illustrate examples of campaign events and event details screens that may be used with certain embodiments of the present disclosure;

FIG. 6B illustrates an example of a share event details screen that may be used with certain embodiments of the present disclosure;

FIGS. 7A and 7B illustrate examples of polling and polling results screens that may be used with certain embodiments of the present disclosure.

FIGS. 8A and 8B illustrate examples of user profile and user profile comment screens that may be used with certain embodiments of the present disclosure;

FIGS. 9A and 9B illustrate examples of user friends and friend request screens that may be used with certain embodiments of the present disclosure;

FIGS. 10A and 10B illustrate examples of newsfeed screens that may be used with certain embodiments of the present disclosure;

FIG. 11 illustrates an example of a CMS account registration screen that may be used with certain embodiments of the present disclosure;

FIG. 12 illustrates an example of a CMS volunteers screen that may be used with certain embodiments of the present disclosure;

FIGS. 13A and 13B illustrate examples of CMS events screens that may be used with certain embodiments of the present disclosure;

FIGS. 14A and 14B illustrate examples of CMS news record screens that may be used with certain embodiments of the present disclosure;

FIGS. 15A and 15B illustrate examples of subscription screens that may be used with certain embodiments of the present disclosure;

FIG. 16 illustrates an example of a report screen that may be used with certain embodiments of the present disclosure; and

FIGS. 17A and 17B illustrate examples of campaign and filter list screens that may be used with certain embodiments of the present disclosure.

### DETAILED DESCRIPTION

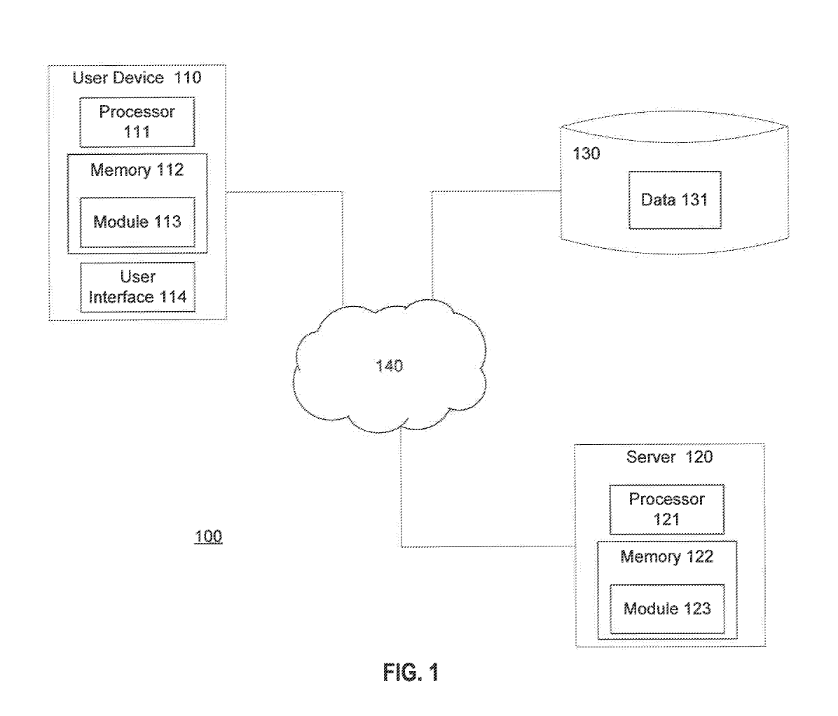

FIG. 1 provides an overview of the architecture of a System 100. System 100 depicts an exemplary system consistent with one embodiment. A user device 110 and a server 120 may be any type of general computing device, such as a mobile computing device, laptop, netbook, server, cell phone, smart phone, personal digital assistant, tablet computer, or any other device capable of executing one or more instructions. User device 110 and server 120 may contain one or more processors, such as a Device Processor 111 and a Server Processor 121. Device Processor 111 and Server Processor 121 may be a central processing unit, a microprocessor, a general purpose processor, an application specific processor, or any device that executes instructions. User device 110 and server 120 may also include one or more memories, such as a Device Memory 112 and a Server Memory 122, that store one or more software modules. Device Memory 112 and Server Memory 122 may be implemented using any non-transitory computer-readable storage media, such as hard drives, CDs, DVDs, flash memory, RAM, ROM, etc. Device Memory 112 may store a User Device Module 113, which may be executed by Device Processor 111. Similarly, a Server Memory 122 may store a Server Module 123, which may be executed by Server Processor 121.

User Device Module 113 and Server Module 123 comprise one or more software applications that provide one or more services, which may relate to volunteer opportunities, campaign contributions, event ticketing, polling, content management, a countdown clock, content pushing, interfaces to social media and social networks such as Facebook, Twitter, etc.

User device 110 may further comprise one or more user interfaces 114. User interface 114 may include one or more of a screen, a display, a projector, a touch panel, a pointing device, a scrolling device, a button, a switch, a motion sensor, an audio sensor, a pressure sensor, a thermal sensor, etc. User interface 114 may allow one or more interfaces to present information to a user. User interface 114 may be web based, such as a web page, and/or a stand-alone application. User interface 114 may also be configured to accept information from a user, such as user feedback. The user may manually enter the information, or it may be entered automatically.

While System 100 depicts a single user device 110, embodiments may include multiple user devices. For example, a first user device may be a user device of a user such as a voter, or member, and a second user device may be used by a candidate, committee, and/or organization.

Voters or members may use user device 110 to log in and out of the system, view volunteer opportunities; apply for volunteer opportunities, contribute to campaigns, purchased tickets to events, respond to polls, upload content, send information to social media outlets, and join and follow candidates, committees, and/or organizations. Each of these exemplary functions is discussed in further detail, below. In some embodiments, purchasing tickets to events or volunteering may automatically add events to a calendar on user device 110.

Campaigns, committees, and/or organizations may use device 110 to sell tickets to events, manage campaign contributions, setup polls, and send content to subscribers. For example, a campaign, committee, and/or organization may enter personalized disclaimers, such as those required by election laws or regulations, to be displayed to voters. In another embodiment, a campaign, committee, and/or organization may set contribution limits, such as those required by election laws or regulations. Then, server 120 or user device 110 may limit contributions by a voter to the set contribution limit. These may be automatically reset after a primary election. In one embodiment, this may include applying the purchase price of one or more event tickets to a contribution amount for a voter or member. The campaign, committee, and/or organization may also be able to track the source of contributions and/or who referred the voter to make a contribution. In some embodiments, a voter or member may subscribe to or follow a campaign, committee, and/or organization without the need to first receive approval from the campaign, committee, and/or organization. A campaign, committee, and/or organization, however, may create groups for which a voter would need approval to join. For example, a voter may send a request to join a particular group, which the campaign may, either approve or deny.

System 100 may also include one or more databases, such as a Database 103. While FIG. 1 depicts Database 130 as a separate device, Database 130 may alternatively be located in user device 110 and/or server 120. Database 130 may be implemented using any database technology known to one of ordinary skill in the art, such as relational database technology or object-oriented database technology.

Database 130 may store data 131 Data 131 may include a campaign contribution data, event data, polling data, content (e.g., photos, videos, and audio account information, etc. Data 131, or portions thereof, may be alternatively or simultaneously stored in server 120 or user device 110. In some embodiments, Database 130 may be integrated with a database for one or more campaigns.

System 100 also may include one or more of a Network 140 for facilitating communications between user device 110, server 120, and/or Database 130. Network 140 may include wireless or wired links, such as mobile telephone networks, Wi-Fi, LANs, WANs, Bluetooth, Internet connections, etc.

Functions of the certain embodiments of User Module 113 and Server Module 123 will now be discussed with reference to the figures. Certain embodiments of the present disclosure may include some or all of the functions discussed herein, as well as future improvements.

User Device and Module

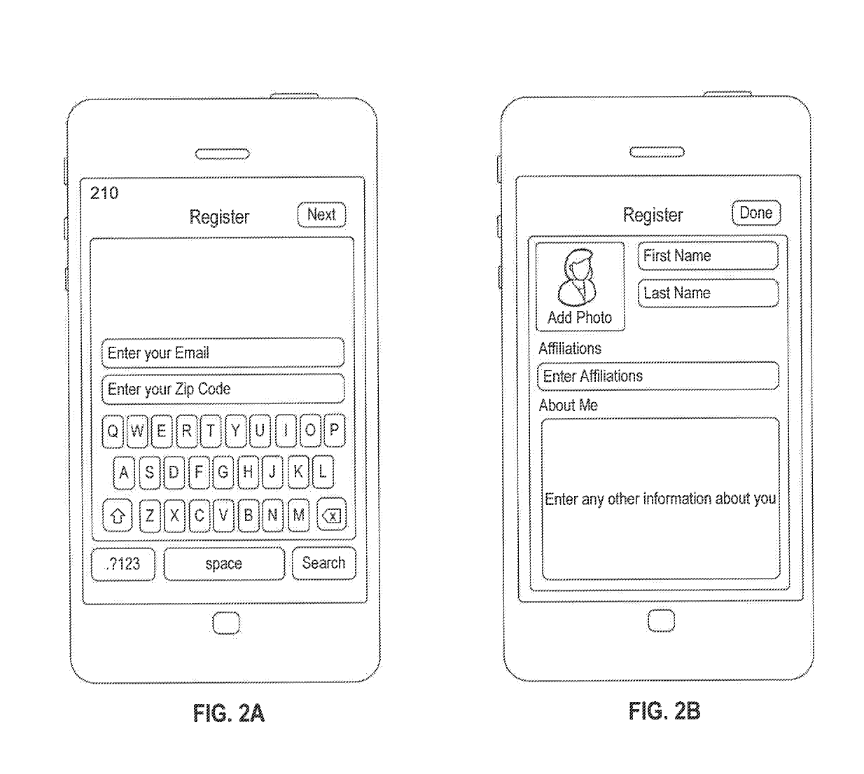

FIG. 2A shows a registration screen 210 which appears when User Device Module 113 is launched for the first time or when there is no registered user saved on the device running User Device Module 113. The user is prompted to enter an email address and geographical location, which may be in the form of town/city and state, or ZIP CODE. Once entered, User Device Module 113 proceeds to the next screen, shown in FIG. 2B, where the user enters personal information such as first and last name, affiliations such as their political party, interest group, or organization, and personal information such as a biography or message the user wishes to appear on their profile.

After an account is created, the user is prompted to login upon launching User Device Module 113, using their ID, which may include entering their email address or other chosen username, and their password. Alternatively, the user's login ID and password information may be saved on user device 110 to automate the login process.

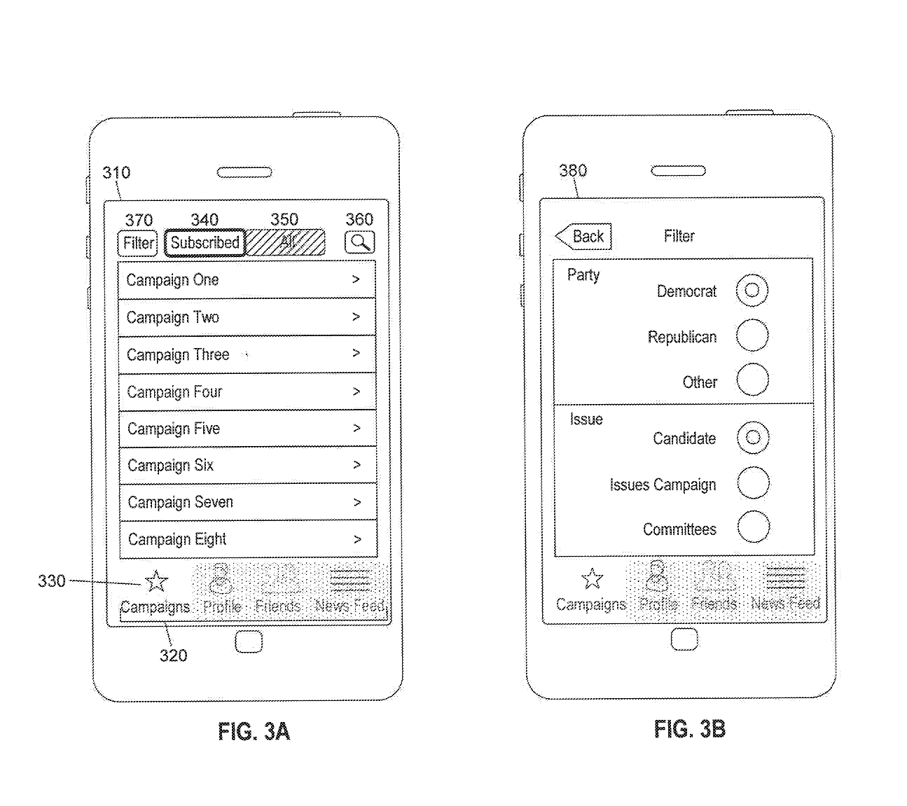

User Device Module 113 contains multiple sections, including campaigns, profile, friends, and news sections. Each section may be accessed by selection of Section Buttons 320 representing the section as shown in FIG. 3A. Section Buttons 320 may be displayed at nearly all times once the user has logged in. As shown in FIG. 3A, a Campaigns Button 330 may be selected by default upon login, and a Campaigns Screen 310 is shown. Alternatively, the user may set a different screen to appear as the default screen upon login.

Campaigns screen 310 displays a list of active campaigns. The list may show campaigns that the user has previously subscribed to by selection of a Subscribed Toggle 340 or may show all active campaigns by selection of an All Toggle 350. User device 110 sends a request to server 120, and server 120 returns a list of subscribed or all campaigns, sorted alphabetically. By selection of a campaign Search Button 360, the user may initiate a search for a particular campaign by name. In response to receipt of the search request, server 120 returns the one or more campaign search results.

From Campaigns Screen 310, the user may filter the campaigns viewed by selecting a Filter Button 370, which opens a Filter Screen 380, shown in FIG. 3B. Filter Screen 380 presents options for the user to filter viewed campaigns, such as filtering by party (Democrat. Republican, other), by type (candidate, issues campaign, committee/organization), by election level (federal, state, local), by office sought in the campaign, or by geographical location (district, city, town, county, state, etc.). A filter option may be preset as a default filter, such as “office sought.” Once the user selects the desired filter(s), a filter request is sent to server 120, which returns the filtered list of results to be displayed on Campaigns Screen 310.

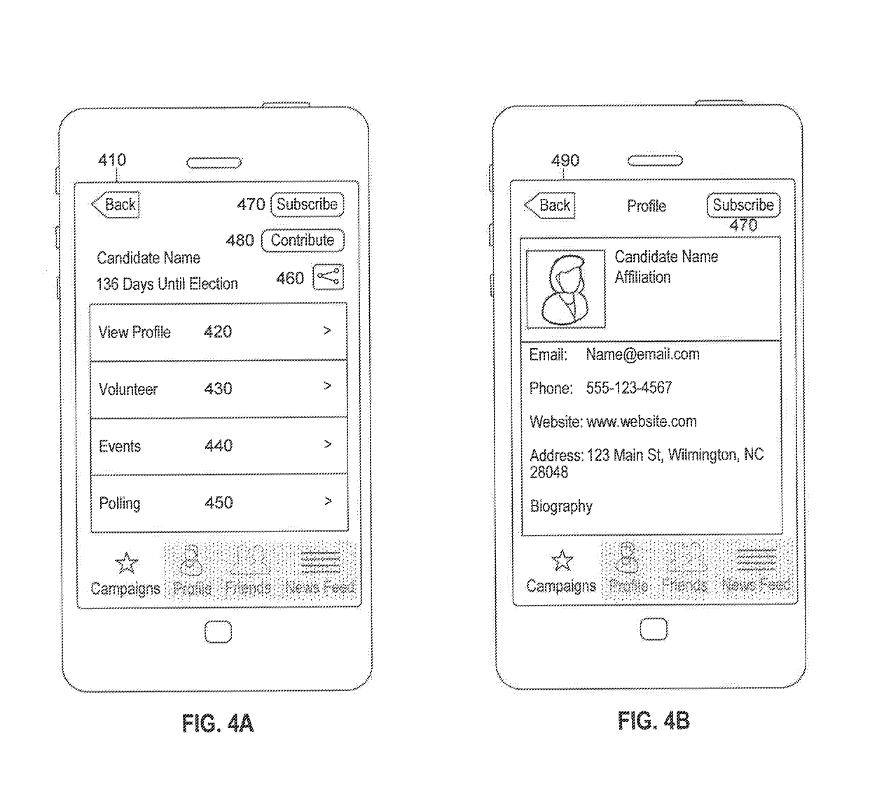

Selection of one of the campaigns from Campaigns Screen 310 (FIG. 3A) shows a Campaign Individual Screen 410, shown in FIG. 4A. Campaign Individual Screen 410 shows information such as candidate name, office sought, and days remaining until election; and contains further links for viewing a Campaign Profile 420, volunteer 430, events 440, polling 450, Sharing 460, or comments (not shown) screens. In some embodiments, volunteer 430, events 440, polling 450, and Sharing 460 buttons may be links activated only for users who are following or have subscribed to the campaign.

Campaign individual screen 410 includes a Subscribe/Follow Button 470. By selecting Subscribe/Follow Button 470, the campaign may be added to the user's list of subscribed campaigns, and the volunteer, events, polling, and share button links are enabled to the user for that campaign. If the user is already a subscriber, an unsubscribe/unfollow button (not shown) may be displayed in place of Subscribe/Follow Button 470, which when selected removes the campaign from the user's subscribed list, and deactivates the volunteer, events, polling, and share button links.

Referring still to Campaign Individual Screen 410 shown in FIG. 4A, users may contribute money to the candidate's campaign by selecting a Contribute Button 480. Selecting Contribute Button 480 launches a contribution screen (not shown), which prompts the user to enter personal info such as their name, occupation, and contribution amount. Then, the user is prompted to enter payment information, such as credit card information. The entered information is forwarded to server 120, where the contribution transaction is processed. Server 120 retains total amounts contributed by various users for each campaign. User contribution limits for each campaign may be set by the candidate to comply with the election or federal guidelines, as discussed in additional detail below.

FIG. 4B shows a Campaign Profile Screen 490, which is viewable by selecting Campaign Profile 420 from the campaign individual screen (FIG. 4A). The profile includes more detailed information about the candidate, such as their picture, name, office sought, affiliations, email address, phone number, website, address, personal statement, and issues of interest. In certain embodiments, the email, phone, and website information maybe be displayed in the form of links. When selected, one of the links launches the appropriate communication application for sending email to a preset email address, making a phone call to a preset number, or visiting a linked website. Also displayed in Campaign Profile Screen 490 is a Subscribe/Follow Button 470, which has the functionality described above.

Referring again to FIG. 4A, while the user is viewing Campaign Individual Screen 410, they may select a Share Campaign Button 460. Upon selecting to share, the user's friends list appears, and allows selection of friends via checkboxes next to each friend (not shown). The user may chose to whom they want to share the campaign, and an invitation to view and subscribe to the campaign is sent to the user's selected friends.

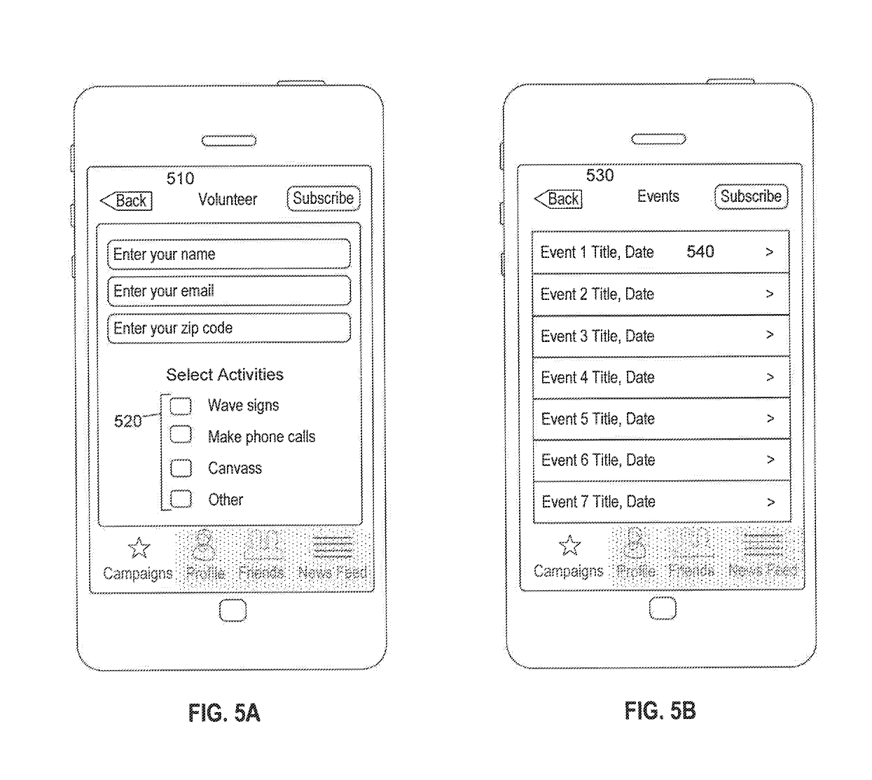

FIG. 5A shows a Volunteer Screen 510, which may be displayed by selecting volunteer 430 on Campaign Individual Screen 410 (shown in FIG. 4A), Volunteer Screen 510 allows the user to volunteer for campaign activities. The user is prompted to enter information including name, contact information such as email, and geographical location such as their ZIP code. The user then indicates one or more desired volunteer activity, by selecting at least one of Activity Checkboxes 520 corresponding to activities such as sign waving, making phone calls, canvassing (walking door-to-door), “I have a sign location,” and other (user-defined activity). Upon completing the information entry on Volunteer Screen 510, the information is transmitted to server 120, and Database 130 is updated.

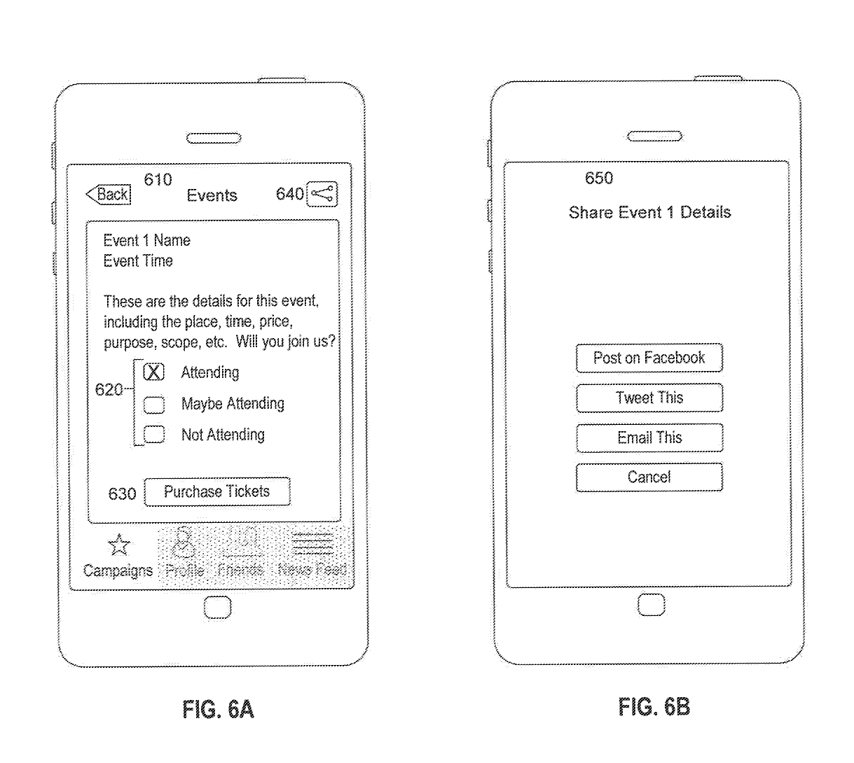

FIG. 5B shows an Events Screen 530, which may be displayed by selecting events 440 on Campaign Individual Screen 410 (shown in FIG. 4A). Upon selecting events 440, server 120 is queried for events scheduled by the campaign, Server 120 returns a list of scheduled events for the campaign, sorted by date. Each Event 540 indicates at least an event title and date. When a particular event is selected, an Event Details Screen 610 is displayed, shown in FIG. 6A. Event Details Screen 610 shows the event name and a description of the event. Attendance buttons 620 are also displayed, for allowing the user to indicate whether they will be attending the event by selecting “Attending,” “Maybe Attending,” or “Not Attending.” Upon selecting “Attending” or “Maybe Attending,” the event may be added to user device 110 calendar. Once the user's selection is submitted, server 120 updates attendance data on Database 130. If tickets are required for the event, selecting “Attending” may activate a Purchase Tickets Button 630, which displays an event ticket screen (not shown) for purchasing/obtaining tickets. The user is prompted to enter payment information. Entered information is transmitted to server 120, where it is directed to a credit card authorization service such as Authorize.net. Server 120 updates event attendance information in Database 130, and updates the user's total contribution amount by adding the ticket purchase price to their total. If the ticket purchase transaction results in the total contribution amount exceeding a preset limit, the transaction is cancelled and the user is notified accordingly.

FIG. 6B shows a Share Event Screen 650 comprising options for sharing the event details with a chosen individual or on the user's social network. Share Event Screen 650 may be displayed by selecting a Share Event Button 640 on Event Screen 610 (shown in FIG. 6A). Share Event Screen 650 may be displayed as a separate screen, or a popup overlaid on Event Screen 610. Share Event Screen 650 allows the user to post the on their social network page, such as Twitter and Facebook. Alternatively, the user may send the event info to a desired recipient by email. If the user selects to share via social network such as Facebook or Twitter, the appropriate standard sharing functionality for that network is launched, and a preset message for the campaign is posted to the user's social network profile. If the user selects to share via email, the user is prompted to select recipients from their phonebook or by manually entering email addresses, and a preset message is transmitted to the email recipients. The preset message for the campaign is discussed in further detail below.

A campaign comments screen may be displayed by selecting a comments button on the campaign individual screen (not shown in figures). Upon selecting the comments button a request is sent to serve 120, and server 120 returns a predetermined number of recent comments, such as the twenty most recent comments, sorted by creation date. Each comment includes user name of the author, date of creation, and body of the comment. The user may scroll through the list of comments, and select to see additional comments (not shown in figure), which queries server 120 for the next predetermined number (i.e. the next twenty) most recent comments.

While viewing the comments screen, the user may generate their own comment (not shown). The user's new comment is sent to server 120, where server 120 validates the comment, and returns acknowledgement to the user. During comment validation, server 120 checks the words in the comment against a filter list. The filter list is a list of words that are not acceptable, or are banned by the campaign. The list may be modified by the campaign account (discussed in further detail below). If the comment contains words from the filter list, the comment is not posted, and the user may receive a message indicating the message content was rejected. Otherwise, validated comments are added to the comments screen.

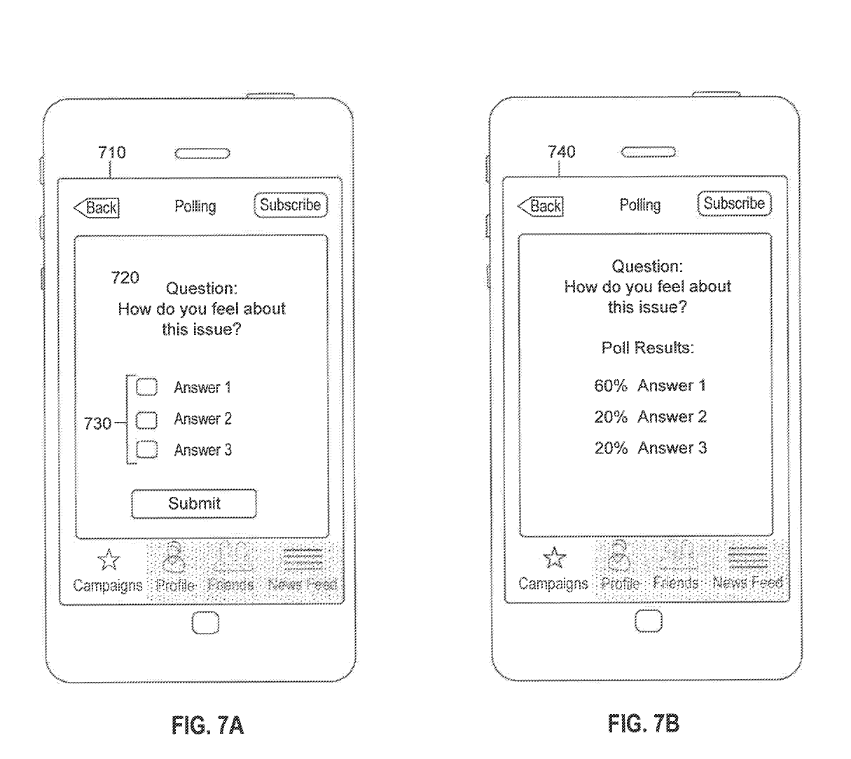

FIG. 7A shows a Polling Screen 710 that may be displayed in certain embodiments, by selecting polling 450 on Campaign Individual Screen 410 (shown in FIG. 4A). Polling Screen 710 displays at least one Polling Question 720, previously created by the campaign, and preset Answer Choices 730 for each of the one or more polling questions. The user may select the answer (or answers if multiple selections are allowed), and submit their response, which is forwarded to server 120. Server 120 receives the response, and returns to the user the questions, answer choices for each question, and the percentage of users who selected each answer in a polling results screen 740, shown in FIG. 7B. The polling information processing may be performed by server 120 or by a polling service such as Poly daddy. The polling results may be forwarded to the user from server 120, or from the polling service.

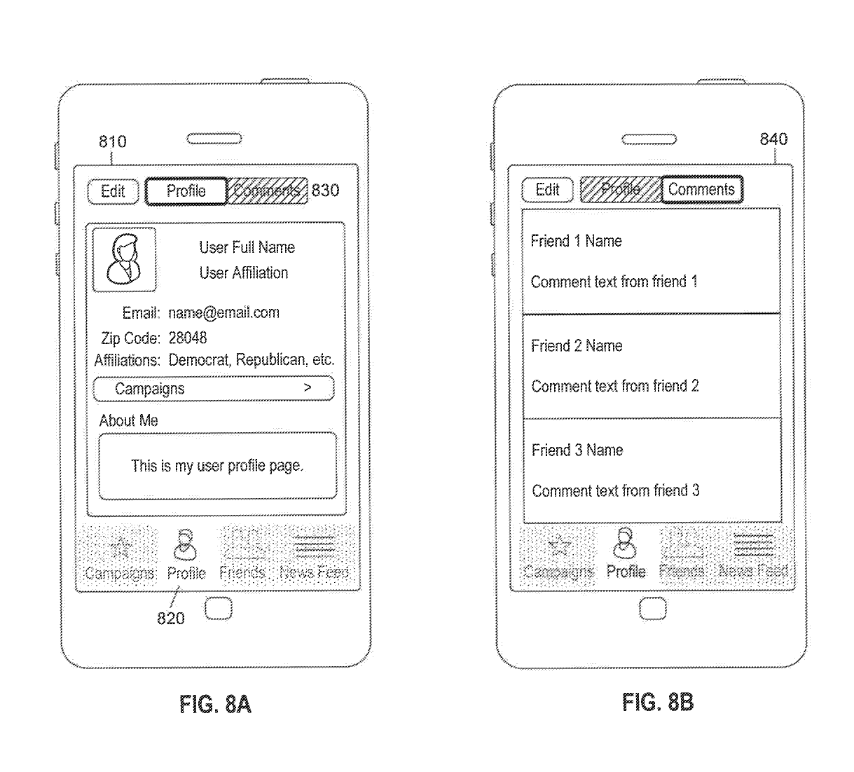

FIG. 8A shows a user Profile Screen 810 that may be displayed by selecting profile 820 present on nearly all User Device Module 113 screens. Profile Screen 810 may be set to display automatically upon logging in to the module. Profile Screen 810 may include profile information such as a profile picture, user name, political party and/or organization affiliation(s), email address, geographical location such as city and state, or ZIP code, occupation, and “about me” information written by the user. The user's own profile information may be edited when viewing their profile. Any edits are validated by server 120 before updating database 130.

A comments toggle button 830 on Profile Screen 810 may be selected to display comments left for the user by other, as shown in FIG. 8B. Selection of the Comments Toggle Button 830 queries server 120 for the twenty most recent comments, which are displayed on a Profile Comments Screen 840. The user may scroll through the comments, and query server 120 for an additional twenty most recent messages by the user (not shown in detail in figures). When the user is viewing their own profile comments, the user may selectively delete comments.

Referring again to the user profile screen shown in FIG. 8A, in certain embodiments a share module button (not shown) may be displayed. The share module button may permit the user to invite others to download the user module and/or join the network. Upon selecting the share module button, a sharing screen is presented (not shown in figures). The user is prompted to select email recipient from their device phone book, or friends list, or add recipients’ email addresses manually. A preset message is sent to chosen recipients that may include active links to download the module.

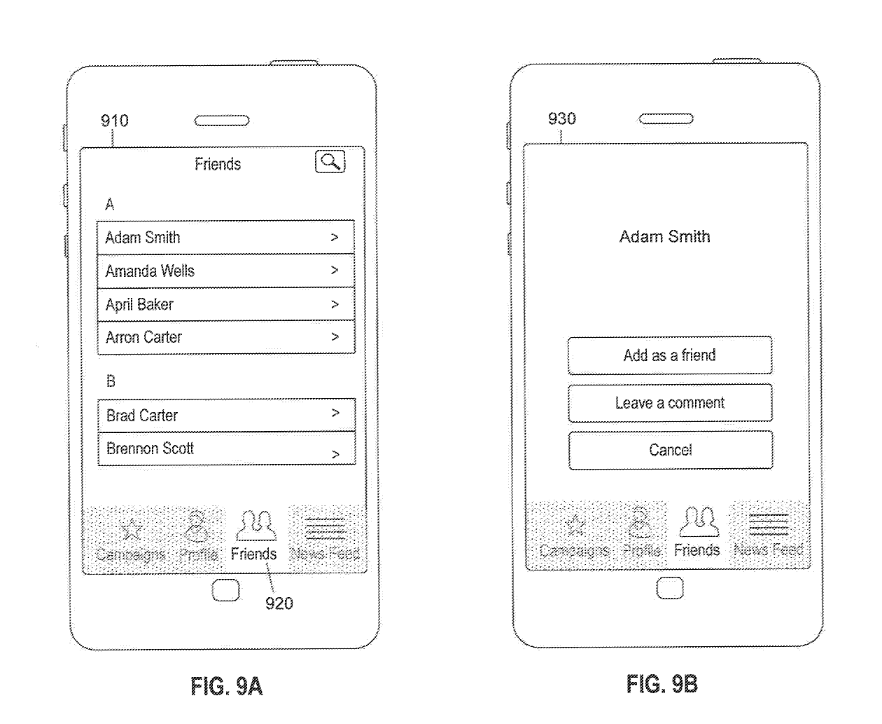

FIG. 9A shows a Friends Screen 910 that may be displayed by selecting a friends 920 present on nearly all module screens. Selection of friends 920 causes a request to be sent to server 120, and server 120 returns the list of other users who are designated as friends, sorted alphabetically. Selection of one of the friends may cause that friend's profile to display.

The user can search for users, by searching for a user name, affiliation, or by campaign that the user is following. The user may then send a friend request via friend request button (not shown) on the profile of a user who is not already a friend. FIG. 96 shows a Friend Request Screen 930 displayed in response to initiating a friend request from a user profile. Furthermore, a friend may be removed from the user's friend list by selection of a remove button (not shown) when viewing the friend's profile. Recipients of friend requests may accept or deny the friend requests. Additionally, users may leave comments on other profiles by viewing their comments, and then adding a new comment by selecting an add comment button (not shown). Alternatively, a new comment may be created from Friend Request Screen 930. All comments are subject to validation by server 120 in a manner similar to that described above.

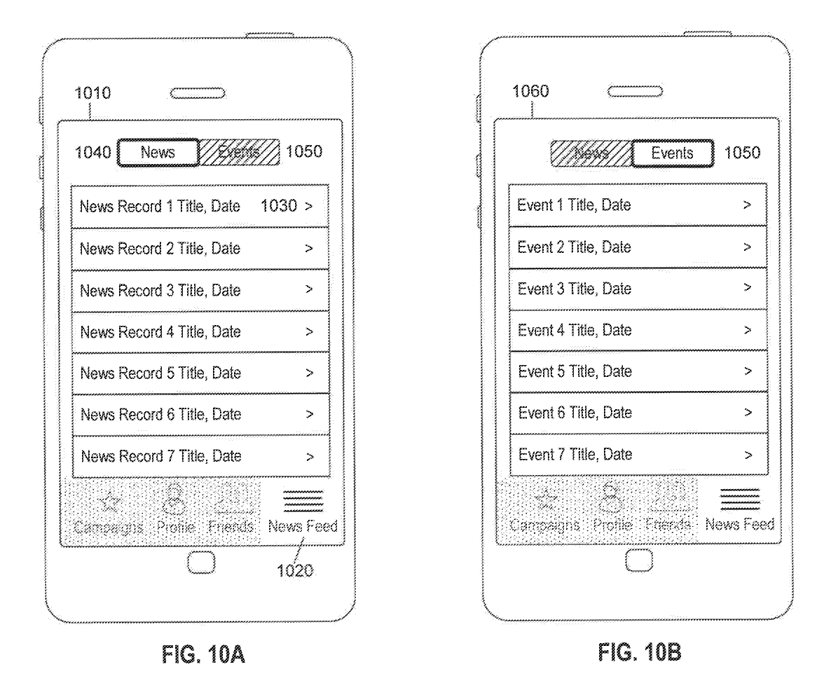

FIG. 10A shows Newsfeed Screen 1010 that may be displayed by selecting newsfeed 1020 present on nearly all User Device Module 113 screens. When the newsfeed button is selected, a request is sent to server 120, and server 120 returns a date-ordered list of news records for campaigns to which the user has subscribed/followed. Each News Record 1030 in Newsfeed Screen 1010 shows the title and date of creation. The user may select a news record to display more details (not shown in figures). The news record details include the title of the story, date of creation, and complete story of the news record.

Referring still to FIG. 10A, a News Toggle Button 1040 and an Events Toggle Button 1050 are displayed at the top of Newsfeed Screen 1010. When News Toggle Button 1040 is selected, a list of news record is displayed as discussed above. When the user selects Events Toggle Button 1050, server 120 returns a list of events sorted by date on a Newsfeed Events Screen 1060, shown in FIG. 10B. The events are returned for campaigns to which the user has subscribed or is following. Each event entry includes the event title and event date. Upon selecting an event, the event details screen for that event is shown. Newsfeed Events Screen 1060 functions similar to Events Screen 610 discussed above (shown in FIG. 6A), and has similar features such as the ability to share event details, purchase tickets, and indicate attendance. The key distinction between the event display screens is that Newsfeed Events Screen 1060 displays events for all subscribed campaigns, whereas Events Screen 610 displays events for a single campaign.

Campaign Management System (CMS) Module

The CMS module is a comprehensive management tool for candidates, organizations, and campaign managers. The CMS module may be a component of Server Module 123, stored on a non-transitory computer readable storage medium Server Memory 122, and executable by Server Processor 121 of server 120. Alternatively, in embodiments having more than one user device 110, at least one user device 110 may execute the CMS module, and at least one other user device 110 execute User Device Module 113. In such embodiments, the CMS module may be a component of User Device Module 113, stored on a non-transitory computer readable storage medium User Device Memory 112, and executable by User Device Processor 121 of user device 110.

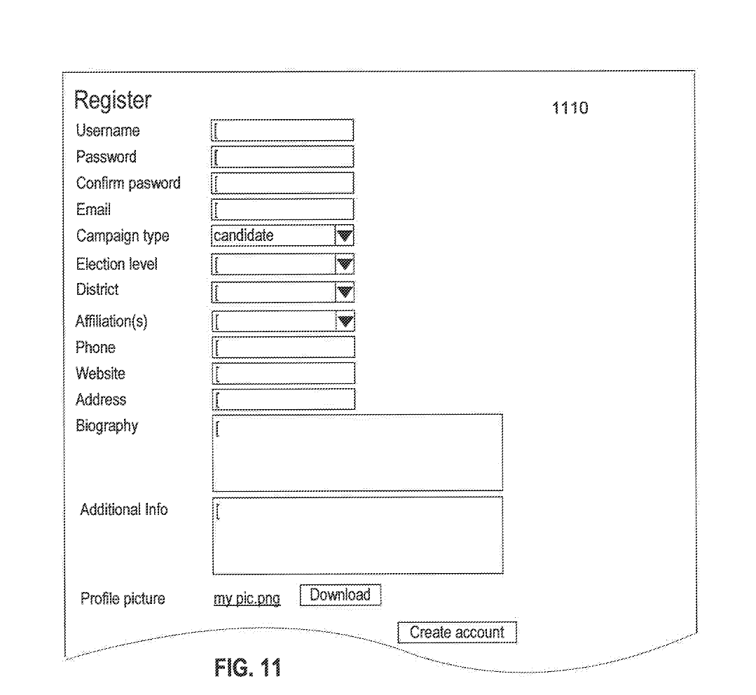

The CMS Module is used by the one or more individuals who are candidates, or campaigns members. For the purposes of this description, the CMS users are referred to as admins. Campaign accounts may require a paid subscription to access CMS functions. Upon launching the CMS Module, the admin is prompted to login to the campaign account with a username and password. If the campaign account is not yet created, the admin is asked to register using CMS Registration Screen 1110, shown in FIG. 11. The admin may register by entering information such as username, password, email, campaign type (such as issues, candidate, committee), election level (such as federal, state, local), district, affiliations (such as Democrat, Republican, other), phone number, website, address, biography (if desired), additional information desired to appear on the campaign individual page, and uploading a profile photo.. When entering the district, a drop down menu may cause an alphabetical list of states to appear. Selecting any state may expand the state into a list of counties. Selecting a county expands the list into cities, and expand cities into districts. All locations are listed alphabetically, and multiple locations may be selected to indicate the geographical scope of the campaign. The admin may edit the lists by adding their own geographical location or district identification at any of the levels as required. Upon completion of the registration, server 120 creates a new account and updates database 130.

In certain embodiments, campaign account registration may comprise additional requests for information. The admin may also have the option to skip these requests until later. One such request may include setting individual contribution limits. The limit amount may be unlimited by default, with an option for the admin to modify the limit to set a maximum amount. Alternatively, the limit may not be preset, and the admin may be required to set a maximum amount as the contribution limit.

In an additional information request, CMS may request the admin to provide text for the preset messages sent a users share event details, or a campaign. The request prompts the admin for the body of the message, and live links to redirect a recipient to the candidate's/campaign's profile or external website. Tailored information requests are provided depending on the format of different social networks or transmission methods. For example, a Twitter preset message is limited to 140 characters. Additionally, preset messages for emails require the entry of an email subject line.

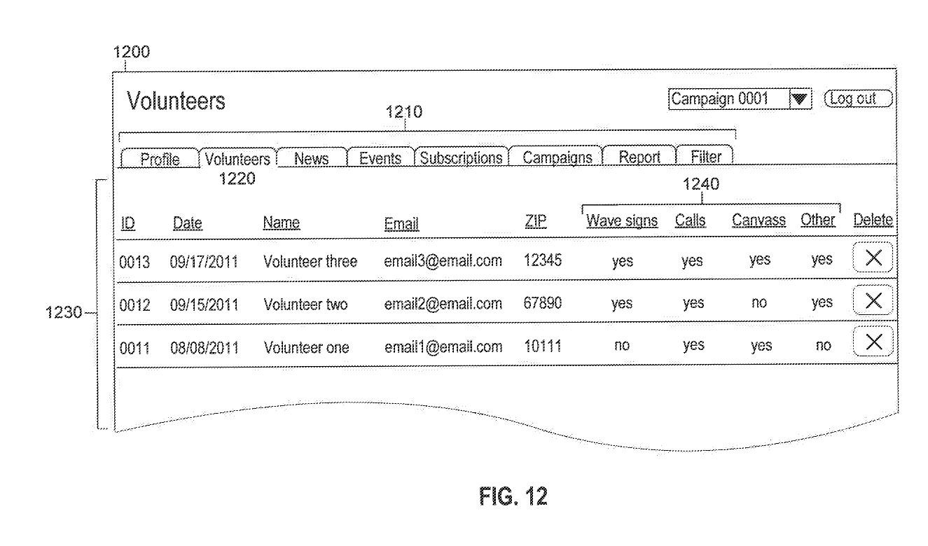

CMS allows the admin, to set up the campaign individual account, and manage aspects of the account from a single user interface. The CMS Module has multiple tabs for accessing different screens. FIG. 12 shows an example of a CMS Module 1200. CMS Module 1200 comprises Tabs 1210 near one edge of the screen, which may be selected to access different sections of CMS. Tabs 1210 may be visible and selectable at all times. When volunteers 1220 is selected, a Volunteers Screen 1230 is shown. Volunteers Screen 1230 displays information regarding users who have expressed a desire to volunteer for the campaign, or are already volunteering. Volunteer information is displayed in a table format including: volunteer ID, date the user volunteered, name, contact information such as phone number or email, ZIP code, and “yes/no” indications for volunteer activities. Volunteer Activities 1240 indicates activities the volunteer has expressed a desire to perform, such as waive signs, phone calls, canvass, or other (user-defined activity). Types of volunteering activities may be preset by the admin for the particular campaign. The admin may sort the table contents by selecting the column for the desired criteria for sorting. Furthermore, the admin may contact volunteer user by clicking the email address or other contact information for the volunteer in the table, Individual volunteers may be deleted from the table by the admin.

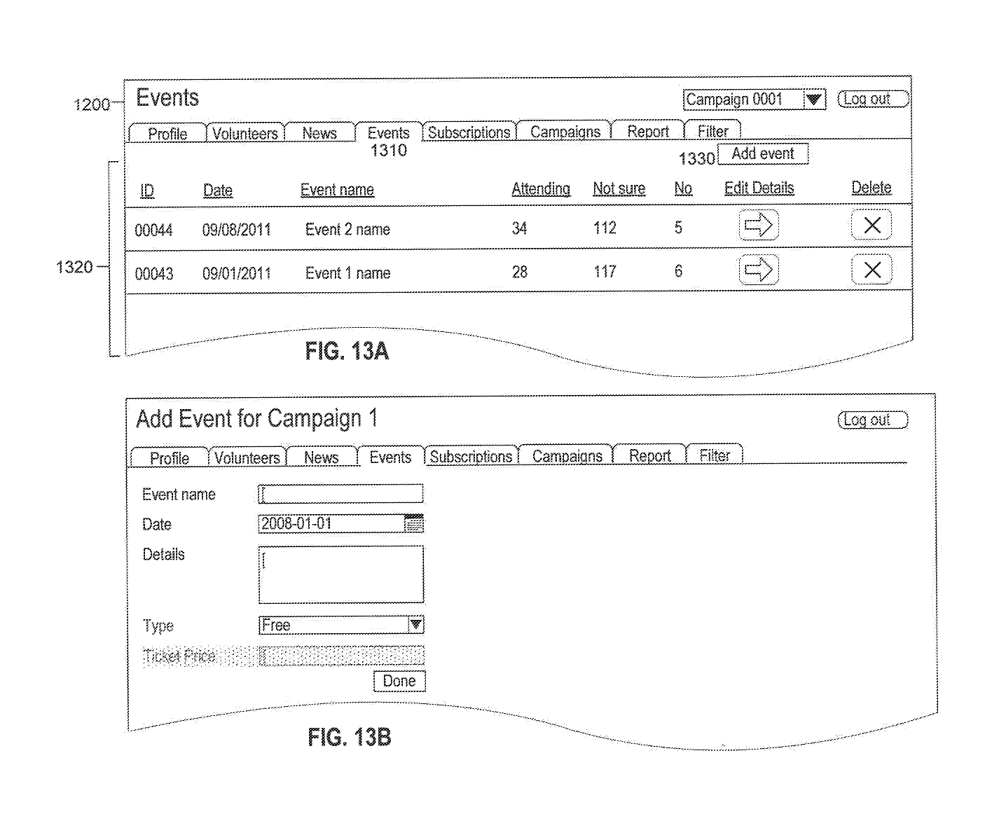

FIG. 13A shows an example of a CMS Events Screen 1320, which is displayed when events 1310 is selected on CMS Module 1200. CMS Events Screen 1310 shows a table of events that have been created by the admin for a particular campaign. The table includes information such as an ID number for the event, event date, event name, number of users attending, maybe attending, and not attending. The admin may view and edit information for a particular event by selecting the event from the list. Events may also be deleted from CMS Events Screen 1310. New events may be created by selecting add event 1330. Upon selecting add event 1330, an add event screen is displayed, shown in FIG. 13B. The admin is prompted to enter information about the event, including the event name, date(s), description/details of the event, whether to send an event notification, whether the event is free or not, and ticket price for paid events. Upon creation of the event, if the admin has chosen to send notifications, server 120 sends a message to subscribed users regarding the new event and ticket availability. Ticket price information may be forwarded to a partnered credit card authorization service such as Authorize.net for handling ticket sales.

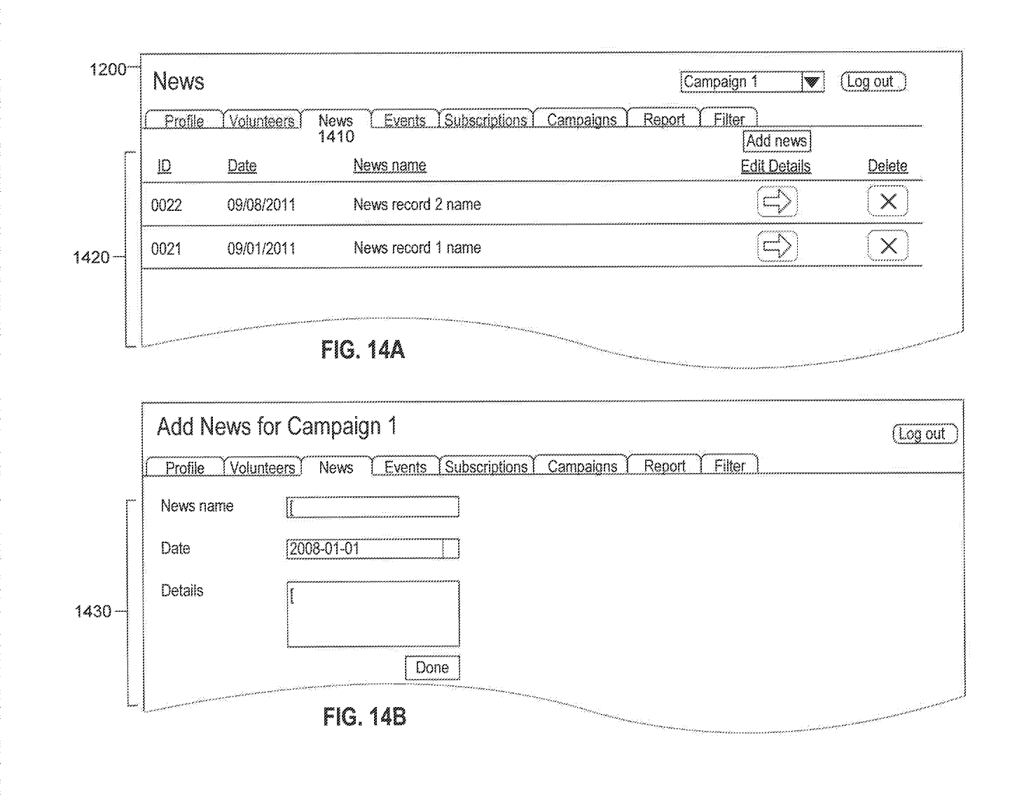

FIG. 14A shows an example of a CMS News Screen 1420, which is displayed when news 1410 is selected on CMS Module 1200. CMS News Screen 1420 shows a table of news records created for the campaign. Each news record entry contains a news record ID number, news record title, and date of the record creation. The admin may view and edit an active news record by clicking that news record from the list. The admin may also add news records, or delete records from the table. When adding news, an Add News Screen 1430 is displayed, shown in FIG. 14B. The admin is prompted to enter news record title, details, and select whether to send notifications (not shown). The user may also enter the date, or the news record may be time stamped automatically by CMS Module 1200 or at server 120. Once the news record is created, server 120 updates database 130. If the admin selected to send notifications, the server 120 sends notifications to subscribed users.

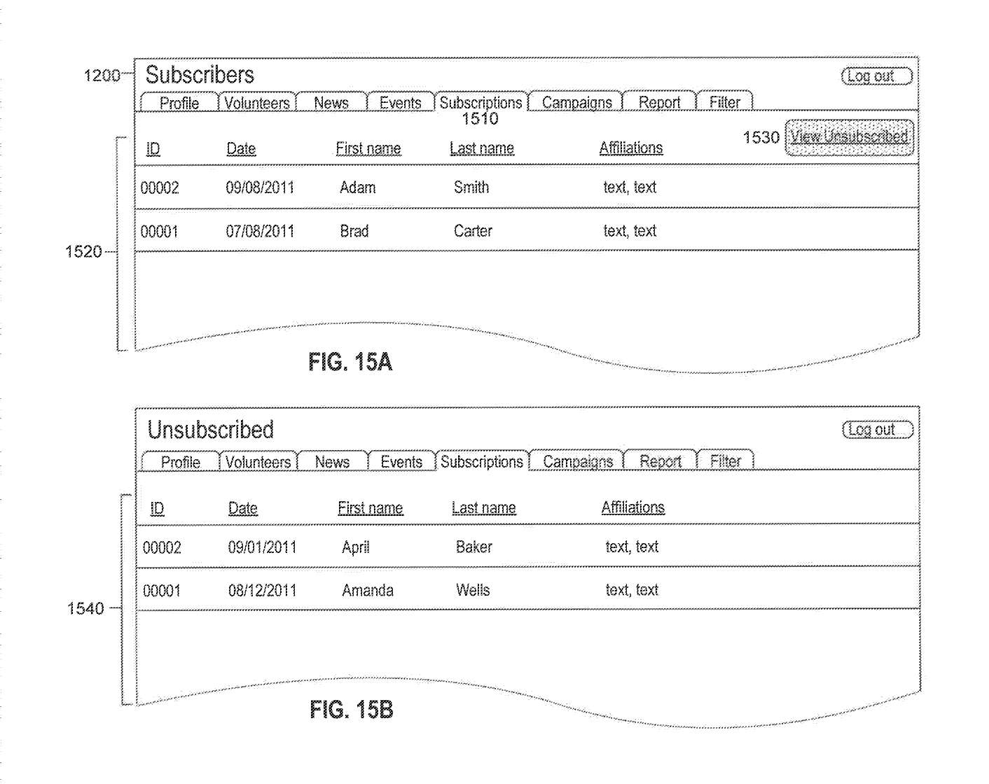

FIG. 15A shows an example of a CMS Subscriptions Screen 1520, which is displayed when subscriptions 1510 is selected on the CMS Module 1200. CMS Subscriptions Screen 1520 shows a table of current subscribed users of the campaign. Subscriber information includes a subscriber ID, date of subscription, first and last name, and affiliations. The table may be sorted by selecting the column of the desired sort criteria. CMS Subscriptions Screen 1520 also includes an Unsubscribed Button 1530 which displays an Unsubscribed Screen 1540 shown in FIG. 15B. Unsubscribed Screen 1540 displays a table of previously subscribed users who have unsubscribed from the campaign, along with their dates of unsubscription.

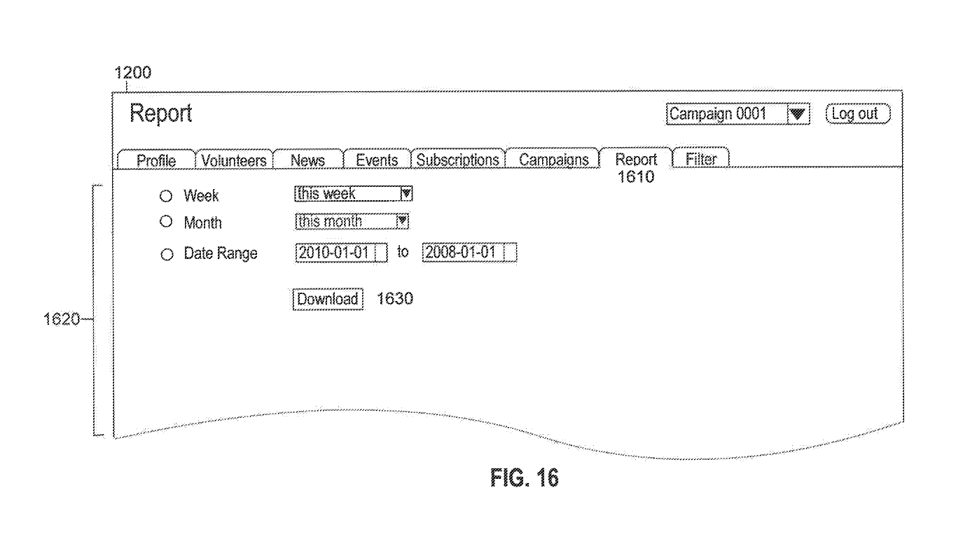

FIG. 16 shows an example of a CMS Report Screen 1620, which is displayed when report 1610 is selected on the CMS Module 1200. CMS Report Screen 1620 allows the admin to request reports from server 120 regarding the campaign. The admin can select a date range for the requested report. The date range may be a preset time interval, such as a week (“this week” or “last week”), or month (“this month” or “last month”). Alternatively, the admin may select a date range by choosing specific start and end dates. The report is generated by server 120 in response to the request, and download 1630 may be selected to download the report. The downloaded report file may be a comma separated value file (.csv), Microsoft Excel spreadsheet, Adobe PDF, or any other suitable format. The report may include campaign information such as the number of event tickets sold, date sold, and total amount of money collected from ticket sales. The report may also include other information such as user contributions, total contributions, and contact information for users who have subscribed and/or contributed. The receipt of user contributions may cause server 120 to forward a transaction record to CMS, showing the contributing user's name, occupation, campaign ID of the contribution, campaign name, date, and contribution amount. These transaction records may be included in the reports generated by server 120. The admin may view and export transaction records containing contribution data only for the campaigns belonging to the account created by the admin.

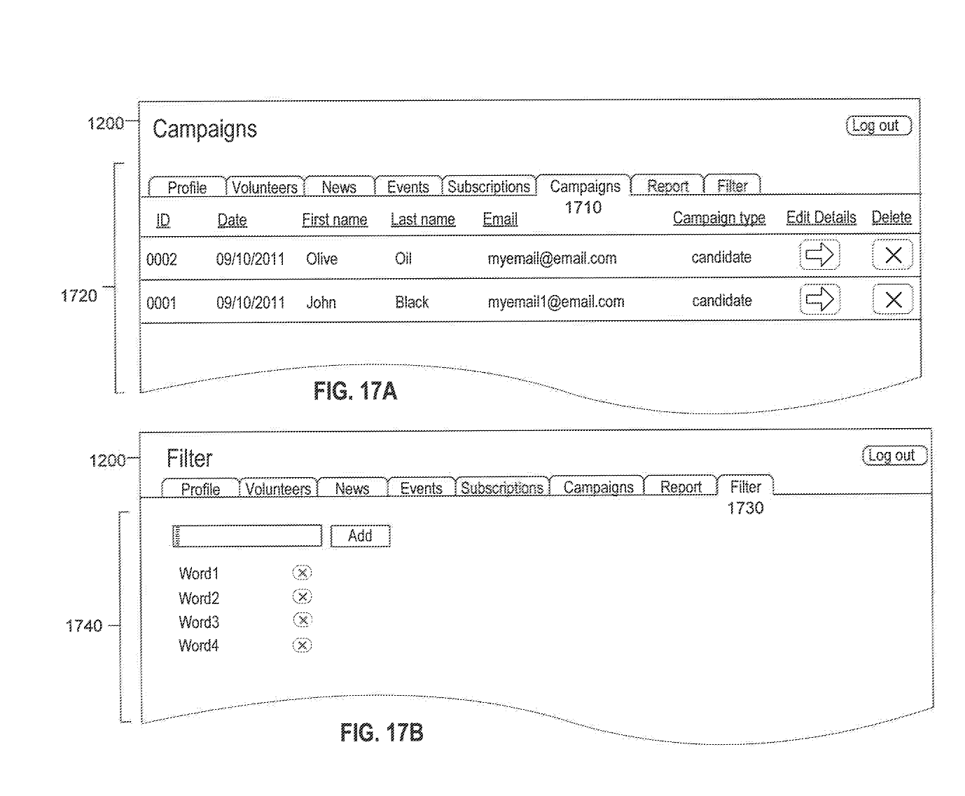

FIG. 17A shows an example of CMS Campaigns Screen 1720, which is displayed when campaigns 1710 is selected on CMS Module 1200. CMS Campaigns Screen 1720 displays a table of campaigns associated with the account. The table includes information for each campaign such as campaign ID number, date of creation, candidate name, contact information such as email address, and campaign type. The table may be sorted by selecting the column of the desired sort criteria. The admin may delete any of the active campaigns. New campaigns may also be created by the admin.

FIG. 17B shows an example of CMS Filter Screen 1740, which is displayed when filter 1730 is selected on CMS Module 1200. CMS Filter Screen 1740 allows the admin to modify the filter list. The filter list may be pre-programmed with words that are generally unacceptable, such as obscenities and profanity, with the option for the admin to add or delete words. Alternatively, the list may be blank by default, where the admin may add words to the blank list. Once the admin has completed editing the list, server 120 updates database 130 with any changes to the campaign's filter list. All incoming comments are checked against the filter list words at server 120. Comments left by users having one or more filter words are deleted from the campaign comments, or are prevented from posting.

The embodiments described herein are exemplary only, and it will be apparent to those skilled in the art that various modifications and variations can be made in the disclosed systems and processes without departing from the scope of the present disclosure. For example, some portions of the user layout as shown in the figures may be rearranged, such as button layouts. Other embodiments of the present disclosure will be apparent to those skilled in the art from consideration of the specification and practice of the present disclosure disclosed herein. It is intended that the specification and examples be considered as exemplary only.

What is claimed is:

1. A computer-implemented method for management of a campaign, committee, or organization, comprising:
storing a profile in a networked database for at least one of a campaign, a committee, or an organization;
receiving a request from a user to purchase a ticket for an event included in the profile;
adding at least a portion of a purchase price to a contribution amount for the user;
comparing the contribution amount to a maximum contribution amount included in the profile;
completing the ticket purchase when the contribution amount is less than or equal to the maximum contribution amount; and
notifying the user when the contribution amount is more than the maximum contribution amount.

2. The computer-implemented method of claim 1 further comprising adding an event to the user's calendar when the ticket purchase is completed.

3. The computer-implemented method of claim 1, wherein the user is a subscriber of the profile.

4. The computer-implemented method of claim 3, further comprising
sending a polling question to the user;
receiving polling response data from the user;
processing the polling data: and
displaying polling results to the user.

5. The computer-implemented method of claim 3, further comprising:
sharing at least one of details for the event or details for the profile on a social network page belonging to the subscriber.

6. A non-transitory computer readable storage medium having stored thereon instructions which when executed cause at least one processor to perform the method comprising:
storing a profile in a networked database for at least one of a campaign, a committee, or an organization;
receiving a request from a user device to purchase a ticket;
adding at least a portion of a purchase price to a contribution amount for the user;
comparing the contribution amount to a maximum contribution amount included in the profile;
completing the ticket purchase when the contribution amount is less than or equal to the maximum contribution amount; and
notifying the user device when the contribution amount is more than the maximum contribution amount.

7. A system for management of a campaign, committee, or organization, comprising:
at least two networked devices;
a database configured to store a user profile and an admin profile for at least one of a campaign, a committee, or an organization; and
a computer network for providing communication between the at least two networked devices and the database,
wherein:
at least one of the networked devices is a user device operated by the user to interact with the admin;
at least one of the networked devices is an admin device operated by the admin to interact with the user; and
the admin profile includes information for at least one event, and a contribution amount limit.
